(19) United States
(12) Patent Application Publication
(10) Pub. No.: US 2024/0291520 A1
(43) Pub. Date: Aug. 29, 2024

(54) AP-BASED ACTION TRIGGERING IN A DISTRIBUTED MASSIVE MIMO SYSTEM

(71) Applicant: Telefonaktiebolaget LM Ericsson (publ), Stockholm (SE)

(72) Inventors: Joao VIEIRA, Hjärup (SE); Erik G. LARSSON, Linköping (SE)

(73) Assignee: Telefonaktiebolaget LM Ericsson (publ), Stockholm (SE)

(21) Appl. No.: 18/573,355

(22) PCT Filed: Jun. 28, 2021
(86) PCT No.: PCT/EP2021/067634

§ 371 Date: Dec. 21, 2023

(51) Int. Cl. H04B 7/024; H04B 7/06

(52) U.S. Cl. CPC H04B 7/024; H04B 7/0617

(57) ABSTRACT

There is provided mechanisms for AP-based action triggering in a distributed massive MIMO system. The distributed massive MIMO system comprises a plurality of APs. The APs are controlled by a central controller and jointly serve UEs. A method is performed by one of the APs. The method comprises determining, per coherence block, at least one instantaneous link performance metric by analyzing uplink signals received from the UEs. The at least one instantaneous link performance metric quantifies channel conditions of one of the UEs for the coherence block. The method comprises performing, for the coherence block and when a comparison between the at least one instantaneous link performance metric for the coherence block and a pre-defined threshold satisfies a trigger condition, a network adapting action for said one of the UEs.

### TECHNICAL FIELD

Embodiments presented herein relate to a method, an access point, a computer program, and a computer program product for access point-based action triggering in a distributed massive multiple-input multiple-output system.

### BACKGROUND

Distributed massive multiple-input multiple-output (MIMO) systems, also known as cell-free massive MIMO systems, rely on phase-coherent operation of large numbers of access points (APs) that are distributed over a larger area. Each AP might comprise multiple antennas elements. All APs might be interconnected with one another via a central controller. When operating in time-division duplexing (TDD) mode, uplink-downlink reciprocity of the radio propagation channel can be exploited in order to estimate the downlink channels using uplink pilot signals.

In state-of-the-art, power control and link adaptation are performed by the central controller under idealistic sets of assumptions and on a slow time scale. For example, power control coefficients are computed as functions of the large-scale fading coefficients (e.g., path losses) and channel correlation properties that change only slowly with time. It is thereby assumed that all interference originates from within the system such that the interference situation is completely known and power control can be performed to achieve given performance targets. In the literature, various schemes for power control are known, for example “max-min fairness” that results in uniform quality of service to all user equipment (UEs) in the coverage area of the distributed massive MIMO system.

A distributed massive MIMO system may be deployed in unlicensed frequency bands. A consequence is that the out-of-system interference cannot be controlled, and that conventional adaptation mechanisms for distributed massive MIMO system power control and beamforming are impaired or even cease to work. In particular, fast fluctuations of interference from other systems operating in the same frequency band might cause quick changes in the instantaneous signal-to-interference and noise ratio (SINR) at a given AP.

Interference may also originate from other sources than other communication links. For example, microwave ovens or industrial equipment can generate electromagnetic interference that impairs communication links. This interference may even be heavy-tailed (e.g., non-Gaussian), which aggravates the impairment. An AP configured to receive signals from a UE that is being subject to heavy uncontrolled interference may not be able to decode the signal, or worse, provide corrupted baseband samples or soft bit information to the central controller which in turn harms the overall decoding process. An additional source of interference is out-of-band leakage from transmitters in adjacent frequency bands. Out-of-band interference mainly results from transceiver hardware nonlinearities. It is known that with multiple-antenna transmitters such interference is directive (e.g., see, E. G. Larsson and L. V.d. Perre, “Out-of-band radiation from antenna arrays clarified,” IEEE Wireless Communications Letters, 2018) and can cause significant harm to nearby receivers in adjacent bands. The use of low-cost hardware with relaxed linearity requirements (or resolution of analog-to-digital converters) at the APs would further amplify this issue.

High-Doppler phenomena might occur in both licensed and unlicensed frequency bands, with Doppler frequencies well beyond those that the distributed massive MIMO system is dimensioned for. High-Doppler phenomena might occur in short bursts of time in the presence of fast-moving vehicles or rotating machinery, for example. When the signal received at an AP is subject to Doppler phenomena beyond the reciprocal slot duration, state-of-the-art mechanisms for channel estimation and beamforming are impaired or even stop working. Continued service of a UE from that AP may result in an overall decreased system performance. Doppler phenomena is a main impartment in systems that rely on reciprocity-based beamforming, which is a main operation mode of distributed massive MIMO systems.

In summary, network adaptation in distributed massive MIMO systems is conventionally performed based on long-term statistics, such as path losses and channel correlation matrices. These statistics are computed by averaging over long time, and change only slowly when unforeseen interference occurs, for example from other systems operating in the same frequency band or from out-of-band transmitters or other man-made sources, or when high-Doppler phenomena occur with short notice. Also, this adaptation is conventionally performed jointly across all APs and performed by a central controller. As a consequence, it takes long time for the system to adapt and react to the situation. Such slow system adaptation may cause the system to declare a beam failure/radio-link failure. Therefore, unnecessary network resources (both in terms of power and signaling) might be spent in order to trigger respective recovering procedures (e.g. new random access procedures, cell re-selection, etc.).

Hence, there is still a need for an improved power control and link adaptation for distributed massive MIMO systems.

### SUMMARY

An object of embodiments herein is to enable efficient power control and link adaptation for distributed massive MIMO systems such that the above issues can be avoided, or at least mitigated or reduced.

A further object of embodiments herein is to configure a distributed massive MIMO system for fast adaptation such that the above issues can be avoided, or at least mitigated or reduced.

According to a first aspect there is presented a method for AP-based action triggering in a distributed massive MIMO system. The distributed massive MIMO system comprises a plurality of APs. The APs are controlled by a central controller and jointly serve UEs. The method is performed by one of the APs. The method comprises determining, per coherence block, at least one instantaneous link performance metric by analyzing uplink signals received from the UEs. The at least one instantaneous link performance metric quantifies channel conditions of one of the UEs for the coherence block. The method comprises performing, for the coherence block and when a comparison between the at least one instantaneous link performance metric for the coherence block and a pre-defined threshold satisfies a trigger condition, a network adapting action for said one of the UEs.

According to a second aspect there is presented a distributed massive MIMO system. The distributed massive MIMO system comprises a plurality of APs for jointly serving UEs. Each of the APs is configured to perform the method according to the first aspect. The distributed massive MIMO system comprises a central controller for controlling the plurality of APs.

According to a third aspect there is presented an AP for AP-based action triggering in a distributed massive MIMO system. The distributed massive MIMO system comprises a plurality of APs. The APs are controlled by a central controller and jointly serve UEs. The AP comprises processing circuitry. The processing circuitry is configured to cause the AP to determine, per coherence block, at least one instantaneous link performance metric by analyzing uplink signals received from the UEs. The at least one instantaneous link performance metric quantifies channel conditions of one of the UEs for the coherence block. The processing circuitry is configured to cause the AP to perform, for the coherence block and when a comparison between the at least one instantaneous link performance metric for the coherence block and a pre-defined threshold satisfies a trigger condition, a network adapting action for said one of the UEs.

According to a fourth aspect there is presented AP for AP-based action triggering in a distributed massive MIMO system. The distributed massive MIMO system comprises a plurality of APs. The APs are controlled by a central controller and jointly serve UEs. The AP comprises a determine module configured to determine, per coherence block, at least one instantaneous link performance metric by analyzing uplink signals received from the UEs. The at least one instantaneous link performance metric quantifies channel conditions of one of the UEs for the coherence block. The AP comprises an action module configured to perform, for the coherence block and when a comparison between the at least one instantaneous link performance metric for the coherence block and a pre-defined threshold satisfies a trigger condition, a network adapting action for said one of the UEs.

According to a fifth aspect there is presented a computer program for AP-based action triggering in a distributed massive MIMO system, the computer program comprising computer program code which, when run on an AP, causes the AP to perform a method according to the first aspect.

According to a sixth aspect there is presented a computer program product comprising a computer program according to the fifth aspect and a computer readable storage medium on which the computer program is stored. The computer readable storage medium could be a non-transitory computer readable storage medium.

Advantageously, these aspects enable efficient power control and link adaptation for the distributed massive MIMO system.

Advantageously, since these aspects are based on actions being taken individually at each AP, the proposed techniques for AP-based action triggering in a distributed massive MIMO system are faster than conventional techniques for power control and link adaptation in distributed massive MIMO systems.

Advantageously, these aspects enable the distributed massive MIMO system to close-to-instantaneously adapt to a number of anomalies in the radio environment that may arise and be discovered within a very short time frame.

Advantageously, these aspects can be used to complement state-of-the-art adaptation mechanisms which are slow as they rely on long-term statistics.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication system according to embodiments;

FIGS. 2 and 3 are flowcharts of methods according to embodiments;

FIG. 4 is a schematic diagram showing functional units of an AP according to an embodiment;

FIG. 5 is a schematic diagram showing functional modules of an AP according to an embodiment; and

FIG. 6 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

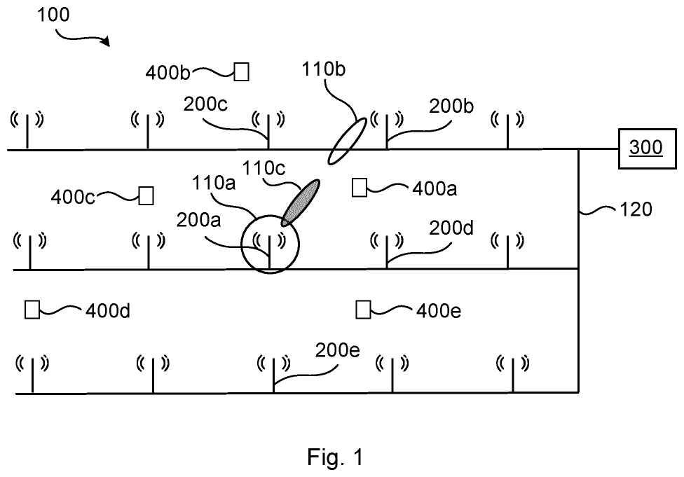

FIG. 1 is a schematic diagram illustrating a communication system 100 where embodiments presented herein can be applied. In some aspects the communication system 100 is a distributed massive MIMO system 100. The communication system 100 will therefore hereinafter be referred to as a distributed massive MIMO system 100. The distributed massive MIMO system 100 comprises APs, five of which are identified at reference numerals 200a, 200b, 200c, 200d, 200e. In this respect, the herein disclosed embodiments are not limited to any particular number of APs 200a:200e as long as there are at least two APs 200a:200e. Each AP 200a:200e could be a (radio) access network node, radio base station, base transceiver station, node B (NB), evolved node B (eNB), gNB, integrated access and backhaul (IAB) node, or the like. The APs 200a:200e operatively connected over interfaces 120 to a central controller 300, which could represent a node in a core network. The APs 200a:200e are configured to provide network access to UEs 400a, 400b, 400c, 400d, 400e. In this respect, the herein disclosed embodiments are not limited to any particular number of UEs 400a:400e. Each such UE 400a:400e could be any of a portable wireless device, mobile station, mobile phone, handset, wireless local loop phone, smartphone, laptop computer, tablet computer, wireless modem, wireless sensor device, Internet of Things (IoT) device, network equipped vehicle, or the like. The APs 200a:200e are configured for wireless communication with each other (as well as with the UEs 400a:400e). In some examples, the APs 200a:200e use beamforming for this communication, as represented by beams 110a, 110b, 110c. Beam 110a is an example of a wide beam, or omni-directional beam, whereas beams 110b, 110c are examples of narrow beams, or so-called pencil beams. Particularly, the APs 200a:200e might simultaneously serve a plurality of the UEs 400a:400e through spatial multiplexing. The signals transmitted by any of the UEs 400a:400e might be received by several APs 200a:200e, and the received signals at these APs 200a:200e are combined according to some post-processing process known in the art. In this respect, each UE 400a:400e is typically associated with multiple APs 200a:200e. Also, typically, all UEs 400a:400 might transmit simultaneously over the entire frequency band, so that all multiplexing (e.g., separation of the UE data) takes place through spatial processing, rather than by time- or frequency-multiplexing.

As noted above, there is still a need for an improved power control and link adaptation for distributed massive MIMO systems 100.

The embodiments disclosed herein therefore relate to mechanisms for AP-based action triggering in a distributed massive MIMO system 100. In order to obtain such mechanisms there is provided an AP 200a:200e, a method performed by the AP 200a:200e, a computer program product comprising code, for example in the form of a computer program, that when run on an AP 200a:200e, causes the AP 200a:200e to perform the method.

The embodiments disclosed herein aim at providing a distributed massive MIMO system 100 capable of fast adaptation and quick reaction to sudden link anomalies (for example, undesirable propagation conditions such as large Doppler spreads, to interference caused, e.g., by neighbor inter-Radio Access Technology systems), and instantaneously adapt the network accordingly. According to the herein disclosed embodiments, this is achieved by executing fast adaptation mechanisms locally at each AP 200a:200e. Each AP 200a:200e might thus detect anomalies in the radio link and take an action accordingly, in an almost instantaneous fashion.

Specifically, a procedure is disclosed where an AP 200a:200e analyzes received UL signals (e.g. reference signals and/or data-bearing signals) to compute relevant link performance metrics. These metrics, which describe the current link conditions, are compared against pre-defined thresholds. The outcome of this comparison may trigger a fast action, causing the AP 200a:200e to adapt itself to the current network situation.

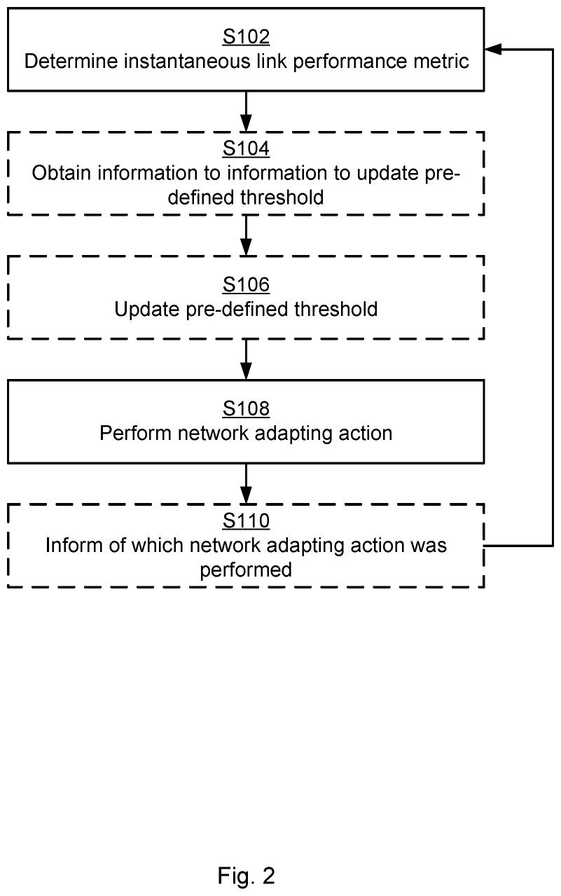

FIG. 2 is a flowchart illustrating embodiments of methods for AP-based action triggering in a distributed massive MIMO system 100. The distributed massive MIMO system 100 comprises a plurality of APs 200a:200e. The APs 200a:200e are controlled by a central controller 300 and jointly serve UEs 400a:400e. The methods are performed by one of the APs 200a:200e. The methods are advantageously provided as computer programs 620.

S102: The AP 200a:200e determines, per coherence block, at least one instantaneous link performance metric. The at least one instantaneous link performance metric is determined by the AP 200a:200e analyzing uplink signals received from the UEs 400a:400e. The at least one instantaneous link performance metric quantifies channel conditions of one of the UEs 400a:400e for the coherence block. As noted above, the uplink signals might be uplink reference signals or data-bearing signals.

S108: The AP 200a:200e performs, for the coherence block and when a comparison between the at least one instantaneous link performance metric for the coherence block and a pre-defined threshold satisfies a trigger condition, a network adapting action for this one of the UEs 400a:400e.

Embodiments relating to further details of AP-based action triggering in a distributed massive MIMO system 100 as performed by the AP 200a:200e will now be disclosed.

In some aspects, the APs 200a:200e are configured for phase-coherent transmissions with other APs 200a:200e. Particularly, in some embodiments, in the distributed massive MIMO system 100, the AP 200a:200e performs phase-coherent transmissions with others of the plurality of APs 200a:200e. In some aspects, the phase-coherent transmissions are controlled by the central controller 300. Particularly, in some embodiments, wherein the AP 200a:200e is controlled by the central controller 300 for performing the phase-coherent transmissions.

As disclosed above, the at least one instantaneous link performance metric is determined per coherence block and the network adapting action is performed for the coherence block. There could be different types of coherence blocks. In some embodiments, wherein the coherence block is a time interval, a frequency interval, or a time-frequency interval over which the AP 200a:200e estimates a radio propagation channel, for which the channel conditions are quantified, to vary less than a threshold value. A coherence block may be the largest time-frequency interval where any pair of channels measured within this interval exhibits, for example, a high channel correlation. The channel correlation may be defined by a correlation coefficient, and high channel correlation may correspond to a correlation coefficient larger than 0.8. In some examples, the coherence block is a time-frequency interval over which the AP 200a:200e estimates the radio propagation channel to be static, for any UE 400a:400e whose mobility speed is less than the maximum mobility speed that the system is designed for. Most systems are designed such that a resource block has the same size or is smaller than a coherence block. In an orthogonal frequency-division multiplexing (OFDM) system, a coherence block typically spans a few OFDM symbols over time, and/or a number of subcarriers in frequency. For example, in 5G-NR, the coherence time (and hence the length in time of the coherence block) is assumed to be that of at least the time of a slot, since the same demodulation reference signal (DMRS) can, in principle, be used to decode all data of that slot. The number of samples in a coherence block (also called its “dimensionality”) is equal to the product of the channel coherence time and the channel coherence bandwidth, which is typically several hundred samples (depending on the carrier frequency; for carrier frequencies higher than 6 GHz, the number of samples could be lower). Each coherence block might in turn partitioned into a pilot part and a data part.

Aspects relating to how the AP 200a:200e might determine, per coherence block, the at least one instantaneous link performance metric, as in S102, will now be disclosed.

As disclosed above, the AP 200a:200e determines one or more instantaneous link performance metrics (or just metrics, for short) which comprise information about the instantaneous/current channel conditions towards a given UE 400a:400e it serves. The purpose of using this information is for network adaptation purposes (as in S108). The determined metrics should, therefore, be pertinent to the types of actions that are performed in S108. The metrics may be determined based on the uplink channel estimates that are computed from received uplink reference signals, such as DMRS and/or SRS, etc.

In general terms, the metrics may be either AP-centric or UE-centric. Particularly, in some embodiments, the at least one instantaneous link performance metric is either AP-centric or UE-centric, or there are at least two instantaneous link performance metrics, at least one of which being AP-centric and at least one of which being UE-centric.

In general terms, an AP-centric metric is a quantity that each AP 200a:200e determines and that is not associated with any specific UE 400a:400e served by that AP 200a:200e. For example, such an AP-centric metric could quantify the interference environment seen at the AP 200a:200e. By way of contrast, a UE-centric metric is a metric that an AP 200a:200e determines for a specific UE 400a:400e, and it may quantify for example the maximum Doppler shift seen for that UE 400a:400e. Particularly, in some embodiments, wherein an AP-centric instantaneous link performance metric is a quantity not associated with any specific of the UEs 400a:400e, and a UE-centric instantaneous link performance metric is a quantity associated with a specific one ofthe UEs 400a:400e.

Further aspects of AP-centric metrics will be disclosed next.

In some non-limiting examples the AP-centric instantaneous link performance metric pertains to noise-plus-interference level experienced at the AP 200a:200e and is expressed in terms of a function of any of: a sample covariance matrix of the signal residuals obtained by subtracting the pilot signal multiplied by the channel estimate from the received pilot signal, second-order statistics of the signal residuals, higher-order moments of the signal residuals.

One rationale for considering noise-plus-interference level experienced at a given AP 200a:200e is that, if the level of noise plus interference experienced at a specific AP 200a:200e is high, then this AP 200a:200e may not contribute significantly in the entire distributed massive MIMO system 100. In this context, the term interference refers to interference that cannot be explained by signals from the UEs 400a:400e that the AP 200a:200e is involved in serving. Specifically, the type of interference envisioned here is primarily interference that the distributed massive MIMO system 100 cannot control. For example, it may be interference caused by a nearby wireless system (i.e. inter-radio access technology (RAT) interference). As a first example, this could be the case when the distributed massive MIMO system 100 operates in an unlicensed frequency band, and another inter-RAT access node transmits simultaneously with the distributed massive MIMO system 100. As a second example, this could be the case when there is severe out-band of interference from an inter-RAT system operating in a nearby frequency band to that of the distributed massive MIMO system 100.

As a specific example of the metric, the noise plus interference level experienced at a given AP 200a:200e may be computed as follows. Let, in the ith coherence block, Yⁱₚ be an M×τₚ matrix of received pilot signals, with M being the number of antennas at the AP and τₚ being the pilot sequence length. Henceforth for conciseness, the coherence block index (i.e., the superscript i) is omitted whenever referring to an individual coherence block. With φₖ being the (appropriately normalized) length-τₚ pilot signal of UE k, the AP 200a:200e may obtain estimates of the channel between UE k and the AP 200a:200e according to,

$${\hat{g}}_{k} = {Y}_{p} {φ}_{k}^{*}$$

This channel is a vector of length M consisting of the complex baseband gains between UE k and each of the M antennas at the AP 200a:200e. Optionally, if side information on the path losses or channel statistics are available, ĝₖ may be weighted. In order to estimate the interference situation, the AP 200a:200e may construct the following residual (for the specific coherence block under consideration):

$$= {Y}_{p} - {\sum }_{k} {\hat{g}}_{k} {φ}_{k}^{T}$$

This residual, [symbol] contains the part of the received uplink pilot signal inside of the coherence block in question, which is not explained in terms of anticipated pilot signal transmissions from the UEs (served by this AP 200a;200e) multiplied by their corresponding channel estimates. If there were no out-of-system interference, [symbol] would consist of only thermal noise plus contributions from channel estimation errors. In the presence of system-external interference, [symbol] will comprise the effects of that interference as well. In order to quantify the nature of the interference environment, the AP 200a:200e may now compute, for example, one or more of the following quantities. [symbol] The sample covariance matrix is denoted [symbol] Y [symbol] ₚ/τₚ and this matrix contains information on the strength of the interference. Its trace (i.e., the sum of diagonal its elements) represents the total magnitude of the interference impinging on the AP 200a:200e within the coherence block in question. The dominant eigenvector of [symbol] [symbol] ₚ(i.e., the eigenvector with the largest eigenvalue) contains information on the directions from which the interference is impinging. Based on analysis of this dominant eigenvector, the AP 200a:200e may infer whether the interference is coming in from one specific direction or not, indicating a particular type of anomaly.

Statistics, such as higher-order moments, for example, the cumulant, of the elements of [symbol] may reveal whether the interference is non-Gaussian, indicating an origin that is not a communication link.

Several variations on this metric are possible. Examples of this will be disclosed next.

In one example, the AP 200a:200e averages the second-order statistics [symbol] [symbol] ₚ/τₚ, or higher-order statistics, over multiple coherence blocks (in time, frequency or both). More specifically, this amounts to computing the following average:

$$\frac{1}{{N}_{c}} {\sum }_{i = 1}^{{N}_{c}} \frac{1}{{τ}_{p}} {\tilde{Y}}_{p}^{i} {\tilde{Y}}_{p}^{i H}$$

where N_{c} is the number of coherence blocks that are involved in the averaging. These coherence blocks involved in the averaging may be either (i) several blocks that lie in parallel in the frequency domain, or (ii) that lie subsequently over time, or (iii) a combination of both. Such averaging results in more accurate measurements of the interference situation (assuming stationarity over time and/or frequency).

In one example, the AP 200a:200e may monitor how estimates of the second order statistics [symbol] [symbol] ₚ/τₚ, or of higher-order statistics, varies between different coherence blocks (that is, over time and/or frequency). Specifically, the AP 200a:200e can obtain the variability of the elements of, or the eigenvalues of, or the norm of, [symbol] [symbol] ₚ^{iH} between different blocks indexed by i. For example, if the interference is pulsating (varying strongly in magnitude over time), this may be an indication of an anomalous situation that prompts a network adapting action to performed.

In one example, the UL signal is first decoded by the AP 200a:200e and treated as a known sequence that is used to estimate the interference statistics in the same manner as {φₖ} is used above. That is, the decoded data are treated as pilot signals for the purpose of the interference statistics estimation. The same formulas as above (with minor modifications, e.g., with φₖ replaced by decoded data) apply. For the AP 200a:200e to confirm the integrity of the decoded uplink data, a standard error-detecting code check (e.g. a cyclic redundancy check; CRC) may be used.

Further aspects of UE-centric metrics will be disclosed next.

In some non-limiting examples, the UE-centric instantaneous link performance metric pertains to at least one of Doppler spread of a radio propagation channel for which the channel conditions are quantified, highest Doppler shift of the radio propagation channel, Doppler shift of strongest path of the radio propagation channel.

The Doppler shift of the strongest path of a radio propagation channel may be estimated by comparing the phase difference between two consecutive measurements of the dominant path of the radio propagation channel, where the measurements are performed in a period of time smaller than the twice the highest possible Doppler shift in the radio propagation environment. One rationale for considering this metric is that, if an AP-to-UE link presents a unreasonably high Doppler shift, then an AP 200a:200e operating at such channel conditions may cause interference during the decoding of received signals at an UE 400a:400e due to channel aging. More specifically, during a downlink transmission where all APs 200a:200e simultaneously transmit to a given UE 400a:400e, and the radio propagation channel associated with one of these APs 200a:200e has high/low Doppler shift, then the transmission from that AP 200a:200e may interfere with the remaining (coherent or even non-coherent) transmissions from the remaining APs 200a:200e to that given UE 400a:400e. Additionally, if the AP-to-UE link is subject to very high Doppler shift, the channel estimate obtained from the uplink part of the coherence block will become outdated during (or even before) the downlink transmission begins, reducing the coherent gain of the downlink beamforming and causing interference. Shrinking the slot length in order to re-train the channel more frequently is a possible remedy to problems with high Doppler shift, but it would impose an increased pilot (training) overhead. These two reasons motivate why Doppler is a suitable metric to be computed for network adaptation purposes.

In some aspects, the at least one pre-defined threshold is updated. Particularly, in some embodiments the AP 200a:200e is configured to perform (optional) steps S104 and S106:

S104: The AP 200a:200e obtains information from the central controller 300 or another of the plurality of APs 200a:200e to update the at least one pre-defined threshold.

S106: The AP 200a:200e updates the at least one pre-defined threshold according to the obtained information.

These thresholds may be upper limits for the metrics disclosed above. For example, there may be an upper limit on the highest Doppler shift that is acceptable for operation, and/or an upper limit on the noise-plus-interference that is acceptable for operation.

For this purpose the central controller 300 might be configured to analyze the state of the entire distributed massive MIMO system 100, compute threshold values for each AP 200a:200e, and forward the thresholds to the APs 200a:200e.

Further, if a nearby AP 200a:200e performs a network adapting action of (temporarily) ceasing its transmissions and/or receptions towards a given UE 200a:200e, this AP 200a:200e may inform its nearby APs 200a:200e, that the nearby APs 200a:200e should be more tolerant towards serving this given UE 400a:400e, e.g. by changing their thresholds.

In this respect, any updating of the at least one pre-defined threshold might occur on the same or on a slower time scale than defined by the coherence block. Further, in some embodiments the at least one pre-defined threshold is updated before performing the network adapting action for the coherence block or before performing the network adapting action for a next occurring coherence block.

Aspects relating to how the AP 200a:200e might compare the at least one instantaneous link performance metric for the coherence block to the pre-defined threshold, as part of S108, will now be disclosed.

In general terms, each computed metric is compared against its respective threshold with the objective of determining if the AP 200a:200e should perform a network adapting action or not. For example, the highest measured Doppler shift may be compared to the associated Doppler threshold, and if the former if larger than the latter, the AP 200a:200e takes performs a network adapting action in order to deal with the issue.

However, more than one comparison between metric and threshold may be made since there may be more than one pair of metric and threshold. Thus, an overall decision as to whether the network adapting action should be performed could take into account the output of all thresholds/metrics comparisons. Particularly, in some embodiments, at least two instantaneous link performance metrics are determined, and, as part of the comparison, either each of the least two instantaneous link performance metrics is compared to a respective pre-defined threshold, or a weighted sum of all of the least two instantaneous link performance metrics is compared to one single pre-defined threshold. One example of such an overall decision, is that the outcome of each threshold/metric comparison may be characterized with a binary digit, and then standard Boolean algebra can be used over all such digits in order to reach an overall decision. For example, assume that X₍₁₎ denotes the outcomes of a first comparison, and assume that X₍₁₎=0 consists of the case of metric 1 not satisfying (i.e. violating) threshold value 1, and assume that X₍₁₎=1 consists of the case of metric 1 satisfying the threshold value 1. Then the overall accounting for all comparisons may be expressed as:

$$X = {X}_{( 1 )} Λ {X}_{( 2 )} Λ … Λ {X}_{( N )} , \qquad ( 1 )$$

where N is the total number of comparisons made (or thresholds/metrics pairs analyzed) and the symbol Λ denotes the logical AND operator. Then, if X=0, performing a network adapting action is triggered since in this case at least one metric did not satisfy its threshold.

Another example of how combine the binary digits describing the results of the threshold/metric comparisons in order to obtain an overall decision variable, is via a weighted sum of the threshold/metric comparisons. Mathematically, this decision variable can be computed as:

$${X}_{w} = {\sum }_{n = 1}^{N} {w}_{n} {X}_{( n )} , \qquad ( 2 )$$

where the ith weight satisfies 0<wᵢ<1, ∀i, and Σₙ₌₁^{N} wₙ=1. The setting of each weight can be based on how important the respective metric is with respect to the overall decision. That is, the more important the metric, the largest its associated weight should be. Based on the binary nature of the comparisons' variables {X₍ₙ₎}, and the constraint on the sum of the weights Σₙ₌₁^{N} wₙ=1, it follows that 0≤X_{w}≤1. With that, the overall decision can be reached via comparing X_{w} with a threshold, for example, 0.5. Then, if X_{w}≤0.5 then performing a network adapting action is triggered, otherwise the network adapting action is not triggered.

Aspects relating to how the AP 200a:200e might perform the network adapting action, as in S108, will now be disclosed.

This step may occur depending on the result of the overall decision in equation (1), or comparison of the decision variable of equation (2) with a threshold. The network adapting action concerns a UE 400a:400e is associated with the metrics analyzed in equation (1). The object of performing the network adapting action is to improve the overall performance of the distributed massive MIMO system 100.

In some aspects, the AP 200a:200e performs network adapting actions in parallel for at least two UEs 400a:400e. Particularly, in some embodiments, a respective at least one instantaneous link performance metric is determined in parallel for at least two of the UEs 400a:400e, and a respective network adapting action for these at least two of the UEs 400a:400e is performed in parallel for the coherence block when a respective comparison between the respective at least one instantaneous link performance metric for the coherence block and a respective pre-defined threshold satisfies the trigger condition.

Different metrics and/or thresholds might here be used for different UEs 400a:400e. Particularly, in some embodiments, the type of instantaneous link performance metric and/or type of pre-defined threshold as used by the AP 200a:200e for making the respective comparison differ for the at least two of the UEs 400a:400e.

In some embodiments, the network adapting action pertains to either start serving one of the UEs 400a:400e when this one of the UEs 400a:400e is not presently served by the AP 200a:200e, or stop serving this one of the UEs 400a:400e when this one of the UEs 400a:400e is presently served by the AP 200a:200e.

In other words, the AP 200a:200e may (at least momentarily) cease transmission and/or receptions of data signaling to the respective UE 400a:400e. In wireless communication standards with a similar frame structure as in fifth generation new radio (5G-NR) telecommunication systems, this may be done on a slot basis, since the frame size is designed under the consideration of channel invariance across a slot. This does not imply that the AP 200a:200e shuts down its hardware circuits, etc., since the same AP 200a:200e could simultaneously also be serving other UEs 400a:400e.

For example, even though the AP 200a:200e itself is currently not serving a particular UE 400a:400e, it may occasionally be listening to reference signal transmissions from this given UE 400a:400e, and use measured channel estimates to execute determine whether or not the AP 200a:200e should also start serving this given UE 400a:400e. In wireless communication standards with a similar frame structure as in 5G-NR this initiation of service may be performed at the beginning of a slot.

In some aspects, the AP 200a:200e informs the central controller 300 and/or other APs 200a:200e of any performed network adapting action. Particularly, in some embodiments the AP 200a:200e is configured to perform (optional) step S110:

S110: The AP 200a:200e informs the central controller 300 and/or others of the plurality of APs 200a:200e of which network adapting action was performed for said one of the UEs 400a:400e.

In some embodiments, the AP 200a:200e further informs the central controller 300 and/or others of the plurality of APs 200a:200e of for which one of the UEs 400a:400e the network adapting action was performed.

In some embodiments, the AP 200a:200e further informs the central controller 300 and/or others of the plurality of APs 200a:200e of the at least one instantaneous link performance metric that triggered the network adapting action to be performed.

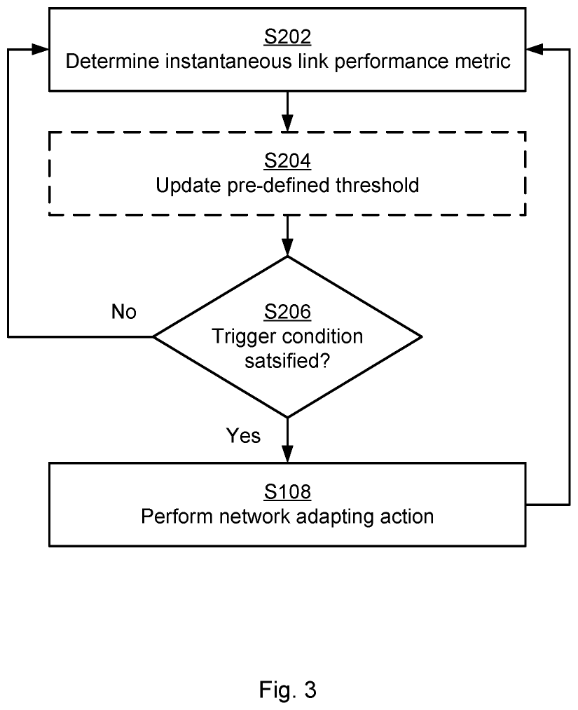

One particular embodiment of a method for AP-based action triggering in a distributed massive MIMO system 100 as performed by the AP 200a:200e will now be disclosed with reference to the flowchart of FIG. 3.

S202: The AP 200a:200e determines, for a current coherence block, at least one instantaneous link performance metric. The AP 200a:200e might thus compute one or more performance metrics which quantify the current channel conditions of a given UE 400a:400e that the AP 200a:200e serves or is a candidate for the AP 200a:200e to start serving.

S204: The AP 200a:200e (optionally) updates the at least one pre-defined threshold according to obtained information. Yet further optionally, step S204 is instead performed before step S202 is entered again for the next coherence block. That is, the order of steps S202 and S204 might be interchanged.

S206: The AP 200a:200e checks if a comparison between the at least one instantaneous link performance metric for the coherence block and a pre-defined threshold satisfies a trigger condition. If the trigger condition is satisfied, step S208 is entered. Else, step S202 is entered again for the next coherence block.

S208: The AP 200a:200e performs, for the current coherence block, a network adapting action for this one of the UEs 400a:400e. Examples of network adapting actions have been disclosed above an apply also here.

The procedure defined by the steps in FIG. 3 (as the procedure defined by the steps in FIG. 2) is defined in the context of a specific AP-to-UE link. As a result, the same AP 200a:200e may execute the same procedure in parallel for another UE 400a:400e, possibly using different metrics and/or thresholds.

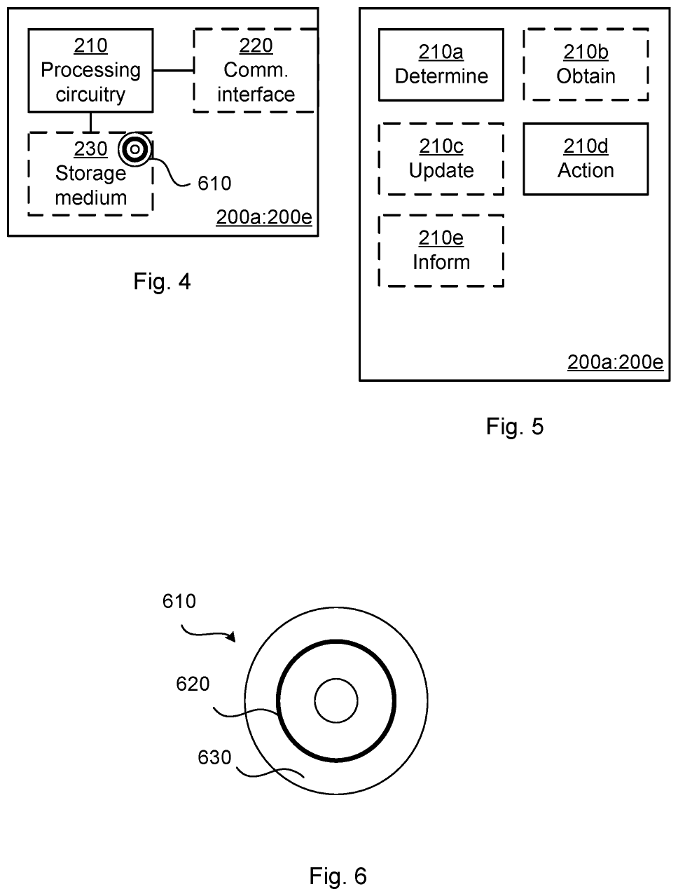

FIG. 4 schematically illustrates, in terms of a number of functional units, the components of an AP 200a:200e according to an embodiment. Processing circuitry 210 is provided using any combination of one or more of a suitable central processing unit (CPU), multiprocessor, microcontroller, digital signal processor (DSP), etc., capable of executing software instructions stored in a computer program product 610 (as in FIG. 6), e.g. in the form of a storage medium 230. The processing circuitry 210 may further be provided as at least one application specific integrated circuit (ASIC), or field programmable gate array (FPGA).

Particularly, the processing circuitry 210 is configured to cause the AP 200a:200e to perform a set of operations, or steps, as disclosed above. For example, the storage medium 230 may store the set of operations, and the processing circuitry 210 may be configured to retrieve the set of operations from the storage medium 230 to cause the AP 200a:200e to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The AP 200a:200e may further comprise a communications interface 220 at least configured for communications with other functions, nodes, entities, and devices, in the distributed massive MIMO system 100. As such the communications interface 220 may comprise one or more transmitters and receivers, comprising analogue and digital components. The processing circuitry 210 controls the general operation of the AP 200a:200e e.g. by sending data and control signals to the communications interface 220 and the storage medium 230, by receiving data and reports from the communications interface 220, and by retrieving data and instructions from the storage medium 230. Other components, as well as the related functionality, of the AP 200a:200e are omitted in order not to obscure the concepts presented herein.

FIG. 5 schematically illustrates, in terms of a number of functional modules, the components of an AP 200a:200e according to an embodiment. The AP 200a:200e of FIG. 5 comprises a number of functional modules; a determine module 210a configured to perform step S102, and an action module 210d configured to perform step S108. The AP 200a:200e of FIG. 5 may further comprise a number of optional functional modules, such as any of an obtain module 210b configured to perform step S104, an update module 210c configured to perform step S106, and an inform module 210e configured to perform step S110. In general terms, each functional module 210a:210e may in one embodiment be implemented only in hardware and in another embodiment with the help of software, i.e., the latter embodiment having computer program instructions stored on the storage medium 230 which when run on the processing circuitry makes the AP 200a:200e perform the corresponding steps mentioned above in conjunction with FIG. 5. It should also be mentioned that even though the modules correspond to parts of a computer program, they do not need to be separate modules therein, but the way in which they are implemented in software is dependent on the programming language used. Preferably, one or more or all functional modules 210a:210e may be implemented by the processing circuitry 210, possibly in cooperation with the communications interface 220 and/or the storage medium 230. The processing circuitry 210 may thus be configured to from the storage medium 230 fetch instructions as provided by a functional module 210a:210e and to execute these instructions, thereby performing any steps as disclosed herein.

The AP 200a:200e may be provided as a standalone device or as a part of at least one further device. For example, the AP 200a:200e may be provided in a node of a (radio) access network. Alternatively, functionality of the AP 200a:200e may be distributed between at least two devices, or nodes. These at least two nodes, or devices, may either be part of the same network part (such as the (radio) access network) or may be spread between at least two such network parts. In general terms, instructions that are required to be performed in real time may be performed in a device, or node, operatively closer to the UEs 400a:400e than instructions that are not required to be performed in real time.

Thus, a first portion of the instructions performed by the AP 200a:200e may be executed in a first device, and a second portion of the of the instructions performed by the AP 200a:200e may be executed in a second device; the herein disclosed embodiments are not limited to any particular number of devices on which the instructions performed by the AP 200a:200e may be executed. Hence, the methods according to the herein disclosed embodiments are suitable to be performed by an AP 200a:200e residing in a cloud computational environment. Therefore, although a single processing circuitry 210 is illustrated in FIG. 4 the processing circuitry 210 may be distributed among a plurality of devices, or nodes. The same applies to the functional modules 210a:210e of FIG. 5 and the computer program 620 of FIG. 6.

FIG. 6 shows one example of a computer program product 610 comprising computer readable storage medium 630. On this computer readable storage medium 630, a computer program 620 can be stored, which computer program 620 can cause the processing circuitry 210 and thereto operatively coupled entities and devices, such as the communications interface 220 and the storage medium 230, to execute methods according to embodiments described herein. The computer program 620 and/or computer program product 610 may thus provide means for performing any steps as herein disclosed.

In the example of FIG. 6, the computer program product 610 is illustrated as an optical disc, such as a CD (compact disc) or a DVD (digital versatile disc) or a Blu-Ray disc. The computer program product 610 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620 is here schematically shown as a track on the depicted optical disk, the computer program 620 can be stored in any way which is suitable for the computer program product 610.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-25. (canceled)

26. A method for access points, AP, -based action triggering in a distributed massive MIMO system, the distributed massive MIMO system comprising a plurality of APs, the APs being controlled by a central controller and jointly serving UEs, the method being performed by one of the APs, the method comprising:
determining, per coherence block, at least one instantaneous link performance metric by analyzing uplink signals received from the UEs, the at least one instantaneous link performance metric quantifying channel conditions of one of the UEs for the coherence block; and
performing, for the coherence block and when a comparison between the at least one instantaneous link performance metric for the coherence block and a pre-defined threshold satisfies a trigger condition, a network adapting action for said one of the UEs.

27. The method according to claim 26, wherein the coherence block is a time and/or frequency interval over which said one of the APs estimates a radio propagation channel, for which the channel conditions are quantified, to vary less than a threshold value.

28. The method according to claim 26, wherein the at least one instantaneous link performance metric is either AP-centric or UE-centric, or wherein there are at least two instantaneous link performance metrics, at least one of which being AP-centric and at least one of which being UE-centric.

29. The method according to claim 26, wherein at least two instantaneous link performance metrics are determined, and wherein, as part of said comparison, either each of the least two instantaneous link performance metrics is compared to a respective pre-defined threshold, or a weighted sum of all of the least two instantaneous link performance metrics is compared to one single pre-defined threshold.

30. The method according to claim 26, wherein a respective at least one instantaneous link performance metric is determined in parallel for at least two of the UEs, and wherein a respective network adapting action for said at least two of the UEs is performed in parallel for the coherence block when a respective comparison between the respective at least one instantaneous link performance metric for the coherence block and a respective pre-defined threshold satisfies the trigger condition.

31. The method according to claim 26, wherein the method further comprises:
obtaining information from the central controller or another of the plurality of APs to update the at least one pre-defined threshold; and
updating the at least one pre-defined threshold according to the obtained information.

32. The method according to claim 26, wherein the network adapting action pertains to either start serving said one of the UEs when said one of the UEs is not presently served by said one of the APs, or stop serving said one of the UEs when said one of the UEs is presently served by said one of the APs.

33. The method according to claim 26, wherein the method further comprises:
informing the central controller and/or others of the plurality of APs of which network adapting action was performed for said one of the UEs.

34. An access point, AP, for AP-based action triggering in a distributed massive MIMO system, the distributed massive MIMO system comprising a plurality of APs, the APs being controlled by a central controller and jointly serving UEs, the AP comprising processing circuitry, the processing circuitry being configured to cause the AP to:
determine, per coherence block, at least one instantaneous link performance metric by analyzing uplink signals received from the UEs, the at least one instantaneous link performance metric quantifying channel conditions of one of the UEs for the coherence block; and
perform, for the coherence block and when a comparison between the at least one instantaneous link performance metric for the coherence block and a pre-defined threshold satisfies a trigger condition, a network adapting action for said one of the UEs.

35. The AP according to claim 34, wherein the coherence block is a time and/or frequency interval over which said one of the APs estimates a radio propagation channel, for which the channel conditions are quantified, to vary less than a threshold value.

36. The AP according to claim 34, wherein the at least one instantaneous link performance metric is either AP-centric or UE-centric, or wherein there are at least two instantaneous link performance metrics, at least one of which being AP-centric and at least one of which being UE-centric.

37. The AP according to claim 34, wherein at least two instantaneous link performance metrics are determined, and wherein, as part of said comparison, either each of the least two instantaneous link performance metrics is compared to a respective pre-defined threshold, or a weighted sum of all of the least two instantaneous link performance metrics is compared to one single pre-defined threshold.

38. The AP according to claim 34, wherein a respective at least one instantaneous link performance metric is determined in parallel for at least two of the UEs, and wherein a respective network adapting action for said at least two of the UEs is performed in parallel for the coherence block when a respective comparison between the respective at least one instantaneous link performance metric for the coherence block and a respective pre-defined threshold satisfies the trigger condition.

39. The AP according to claim 34, wherein the method further comprises:
obtaining information from the central controller or another of the plurality of APs to update the at least one pre-defined threshold; and
updating the at least one pre-defined threshold according to the obtained information.

40. The AP according to claim 34, wherein the network adapting action pertains to either start serving said one of the UEs when said one of the UEs is not presently served by said one of the APs, or stop serving said one of the UEs when said one of the UEs is presently served by said one of the APs.

41. The AP according to claim 34, wherein the method further comprises:
informing the central controller and/or others of the plurality of APs of which network adapting action was performed for said one of the UEs.

42. A computer program product comprising:
a computer program for access point, AP, -based action triggering in a distributed massive MIMO system, the distributed massive MIMO system comprising a plurality of APs, the APs being controlled by a central controller and jointly serving UEs, the computer program comprising computer code which, when run on processing circuitry of one of the APs, causes said one of the AP to:
determine, per coherence block, at least one instantaneous link performance metric by analyzing uplink signals received from the UEs, the at least one instantaneous link performance metric quantifying channel conditions of one of the UEs for the coherence block, and
perform, for the coherence block and when a comparison between the at least one instantaneous link performance metric for the coherence block and a pre-defined threshold satisfies a trigger condition, a network adapting action for said one of the UEs; and
a computer readable storage medium on which the computer program is stored.
